(19) United States
(12) Patent Application Publication
(10) Pub. No.: US 2017/0355177 A1
(43) Pub. Date: Dec. 14, 2017

(54) METHOD FOR FORMING A PANEL, PARTICULARLY SKIN FOR A HOLLOW CORE DOOR, AND A METHOD OF MANUFACTURING A HOLLOW CORE DOOR

(71) Applicant: Fahiem Amod Bux, Port Shepstone (ZA)

(72) Inventor: Fahiem Amod Bux, Port Shepstone (ZA)

(21) Appl. No.: 15/527,580

(22) PCT Filed: Nov. 17, 2015
(86) PCT No.: PCT/ZA2015/050024

§ 371 Date: May 17, 2017

(30) Foreign Application Priority Data
Nov. 17, 2014 (ZA) 2014/08426

(51) Int. Cl. B32B 21/06; B32B 37/12; B32B 7/12; B32B 38/00; B32B 3/30; B32B 21/02; B32B 37/10

(52) U.S. Cl. CPC B32B 21/06; B32B 21/02; B32B 37/1207; B32B 37/1009; B32B 38/0012; B32B 3/30; B32B 7/12; B32B 2607/00; B32B 2038/0016

(57) ABSTRACT

This invention relates to a method for forming a panel or skin for a hollow core door, a method of manufacturing a said door, a hollow core door, a panel, and an apparatus for forming a panel and skin for a hollow core door. The method comprises providing a substrate comprising a patterned groove therein; applying a laminating material on the substrate with an adhesive. The method then comprises sealing the substrate with the laminating material thereon in a chamber and providing at least one deformable membrane adjacent the laminating material; removing air from the chamber wherein under vacuum, the deformable membrane deforms into the groove thereby urging the laminating material into the groove; heating the laminating material to facilitate bonding thereof to the substrate; and allowing the substrate with the laminating material thereon to cool so as to form a panel with the laminating material bonded thereto.

### FIELD OF THE INVENTION

THIS INVENTION relates generally to a method for forming a panel or skin for a hollow core door, a method for manufacturing hollow core door, a hollow core door, and a panel or skin for a hollow core door.

### BACKGROUND OF THE INVENTION

Panels comprising a substrate, for example, fibreboard such as MDF (Medium-density Fibreboard) or LDF (Low-density fibreboard) are often laminated with a sheet of vinyl or PVC (Polyvinyl Chloride) to give an aesthetically pleasing finish, for example, a wood grain or colour finish. These panels are essentially of the type from which relatively low cost doors, etc. are constructed. However, conventionally, the use of vinyl for laminating a substrate makes manufacturing of laminated panels with decorative grooves therein difficult and expensive.

In the case of hollow core doors, these panels are often terms skins and are used to provide one or two of the major faces of said doors.

It is thus an object of the present invention at least to address this difficulty and/or provide an alternate means for laminating a panel or skin for a hollow core door.

### SUMMARY OF THE INVENTION

According to a first aspect of the invention, there is provided a method for forming a panel or skin for a hollow core door, the method comprising:
providing fibreboard substrate comprising a groove pattern therein;
applying a paper or paper-like laminating material on the substrate with an adhesive therebetween;
sealing the substrate with the paper laminating material thereon in a chamber and providing at least one deformable membrane adjacent the paper laminating material;
removing air from the chamber so as to form a vacuum therein, wherein under vacuum, the deformable membrane deforms into the groove pattern thereby urging the paper laminating material into the groove pattern,
heating the paper laminating material on the substrate so as to facilitate bonding of the paper laminating material to the substrate; and
allowing the substrate with the laminating material thereon to cool so as to form a panel or skin with the laminating material suitably bonded thereto.

The method may comprise the step of applying the adhesive to one or both of the substrate or the laminating material allowing the adhesive to cool for a predetermined period.

The step of heating the paper laminating material may operatively activate the adhesive.

The method may comprise sanding the surface of the substrate prior to the application of adhesive thereto.

The membrane may be elastically deformable, wherein the method comprises the membrane elastically deforming so as to urge the laminating material into the groove pattern, at least in response to the vacuum generated in the chamber.

The method may comprise applying a force to the membrane so as to drive the membrane to urge the laminating material into the groove pattern.

It will be appreciated that the laminate material may be a sheet-like laminate material.

The method may comprise pressurising a zone above the membrane pneumatically so as to drive the membrane to urge the laminating material into the groove pattern.

The method may comprise locating the substrate with the laminating material thereon in a substantially hermetically sealable chamber prior to heating the laminating material via the membrane.

The method may comprise the step of trimming excess laminating material from a periphery of the panel.

The method may comprise either forming the panel or skin prior to attachment to a hollow frame door, or while the substrate is attached to the hollow frame door.

According to a second aspect of the invention, there is provided a method of manufacturing a hollow core door, the method comprising attaching one or a pair of panels or skins formed according to the method as described above to at least lateral walls of the hollow core door such that the one or pair of panels or skins serve as one or both major faces of the hollow core door. In one example embodiment lateral sides extend transversely to parallel panels or skins.

The method may comprise attaching the one or pair of panels or skins to the lateral walls of the hollow core door by way of one or more of adhesives, nails, screws, and staples.

A hollow core door comprising at least one panel formed according to the method of forming a panel or skin as described above.

A panel or skin formed in accordance with a method as described above.

According to a third aspect of the invention, there is provided an apparatus for forming a panel or skin for a hollow core door, the apparatus comprising:
a sealable chamber comprising an elastically deformable lid to provide access to the chamber, the chamber being shaped and configured to receive a substrate of the panel or skin to be formed;
a heater configured to heat the sealable chamber;
a vacuum device configured to remove air from the sealable chamber, in use, thereby substantially forming a vacuum therein;
control circuitry to control the heater one or both of the heater and vacuum device.

The apparatus may comprise a frame on which a bed on which the substrate is locatable.

The lid may be displaceable relative to the bed and/or the frame between first and second positions wherein in the first position, access to the chamber is provided and wherein in the second position the lid sealing engages the bed and/or the frame so as to define the chamber.

The lid may be configured to be elastically deformable in response to at least the vacuum formed in the chamber.

The apparatus may comprise sealing members adjacent peripheries of the lid and the bed and/or frame.

The apparatus may comprise a pressure means to apply a force to the membrane, in use, so as to facilitate driving the laminating material in the groove. The pressure means may be in the form of a pneumatic pressurising means configured to apply a pneumatic pressure above the membrane so as to urge the membrane to engage with the substrate, in use.

### BRIEF DESCRIPTION OF THE DRAWINGS

FIG. 1 shows a side view of an apparatus in accordance with an example embodiment of the invention;

FIG. 2 shows another side view of an apparatus in accordance with an example embodiment of the invention;

FIG. 3 shows a top schematic view of an apparatus in accordance with an example embodiment of the invention without the lids and heater;

FIG. 4 shows an end view of an apparatus in accordance with an example embodiment of the invention without the rollers;

FIG. 5 shows an illustrative sectional side view of a panel in accordance with an example embodiment of the invention;

FIG. 6 shows an illustrative front view of a portion of a panel in accordance with an example embodiment of the invention; and

FIG. 7 shows an illustrative front view of a panel for a door in accordance with an example embodiment of the invention.

### DESCRIPTION OF PREFERRED EMBODIMENTS

In the following description, for purposes of explanation, numerous specific details are set forth in order to provide a thorough understanding of an embodiment of the present disclosure. It will be evident, however, to one skilled in the art that the present disclosure may be practiced without these specific details.

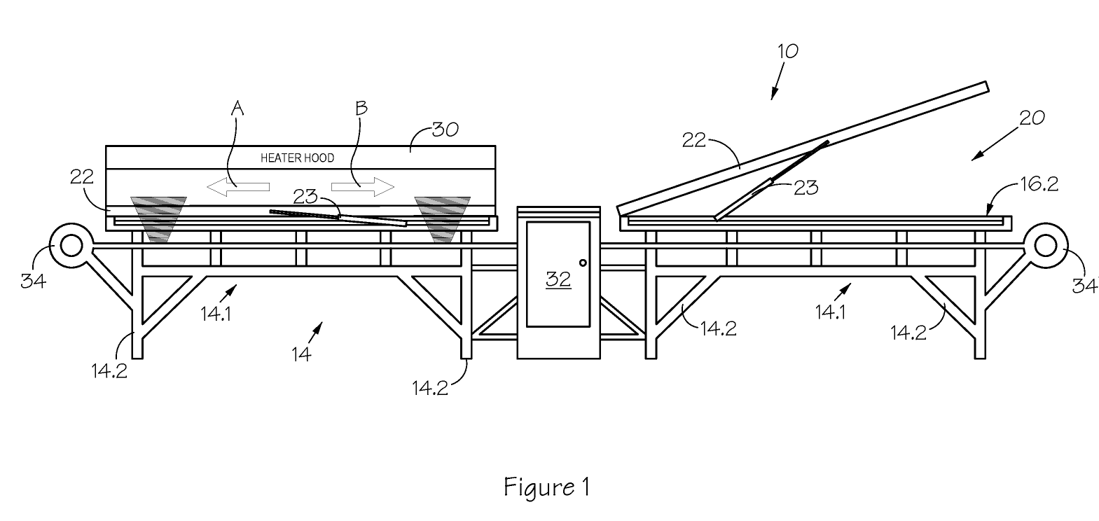

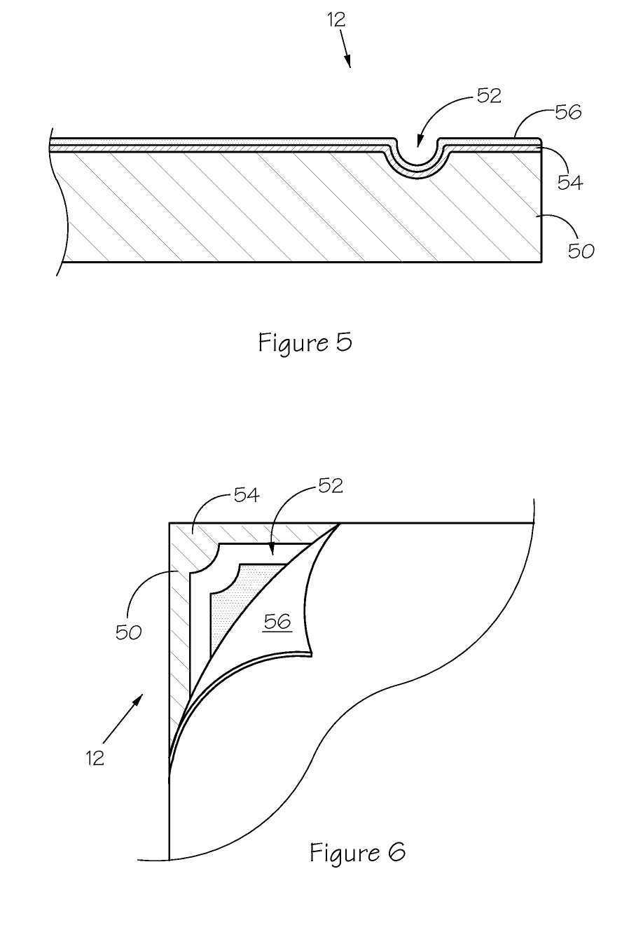

In FIGS. 1 to 4, an apparatus in accordance with an example embodiment of the invention is generally indicated by reference numeral 10. The apparatus 10 is typically for use in forming panels 12 as illustrated in FIGS. 5 to 7 as will be discussed in greater detail below.

The apparatus 10 comprises a table-like frame 14 constructed of steel tubing forming the base of the apparatus 10. In particular, the frame 14 comprises elongate rectangular top 14.1 resting on legs 14.2. The frame 14 defines a pair of beds or tables 16.1, 16.2 which are longitudinally spaced from each other long the top 14.1 of the frame 14. The beds 16.1, 16.2 are shaped and/or dimensioned to receive panels of a particular shape and/or dimension therein for processing as described below.

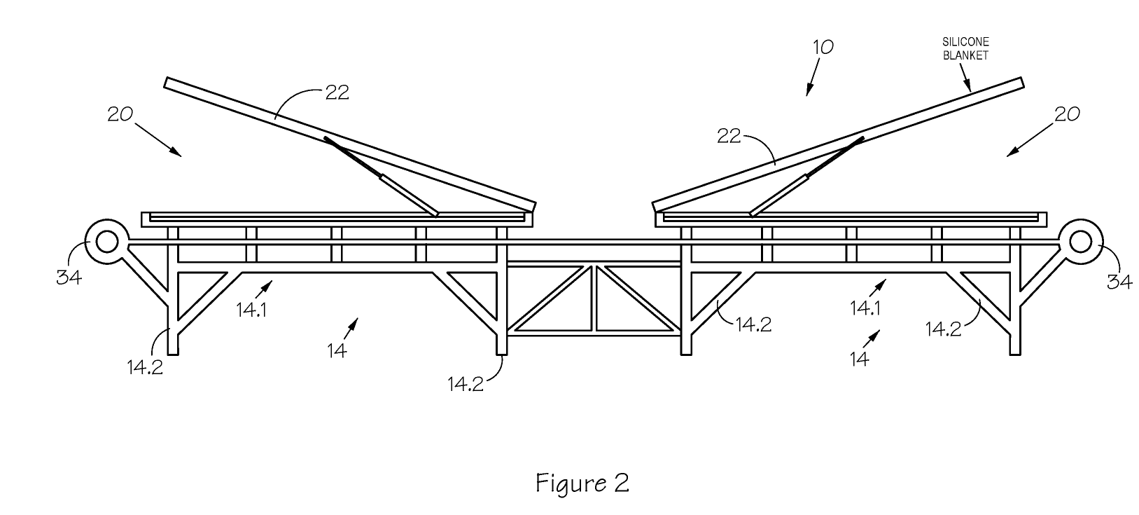

The apparatus 10 comprises a chamber or zone 20 within which the tables 16.1, 16.2 are located. The chamber 20 comprises a lid 22 which essentially allows access to and defines the chamber 20, in use. In particular, the lid 22 is hingedly displaceable between a first position as illustrated in FIGS. 2 and partially in FIG. 1 where the chamber 20 is accessible for location of a panel 12 therein, and a second position as illustrated partially in FIG. 1 wherein the lid 22 is closed thereby sealing the chamber 20 in an airtight fashion, in use, as will be described below.

To assist in operation of the lid 22 between first and second positions, a gas lift assist device 23 (FIG. 1) is operatively connected between the lid 22 and the frame 14.

Though the lid 22 provides access to the chamber 20 by essentially forming the same in the illustrated example embodiment, it will be appreciated that in other example embodiments the chamber may be a separate enclosure having a lid or door to simply provide access thereto.

Peripheries of the lid 22 and/or the bed 16.1, 16.2 may comprise a silicone seal 24 such that when the lid 22 engages the bed 16.1, 16.2, the chamber 20 is sealed in an airtight fashion. To this end, the lid 22 may comprise a latching mechanism to securely seal the chamber 20. The lid 22 is typically planar and is elastically or resiliently deformable and may be located within a rectangular rigid frame. The lid 22 may be constructed of silicone and may thus be in the form of a silicone membrane or mat.

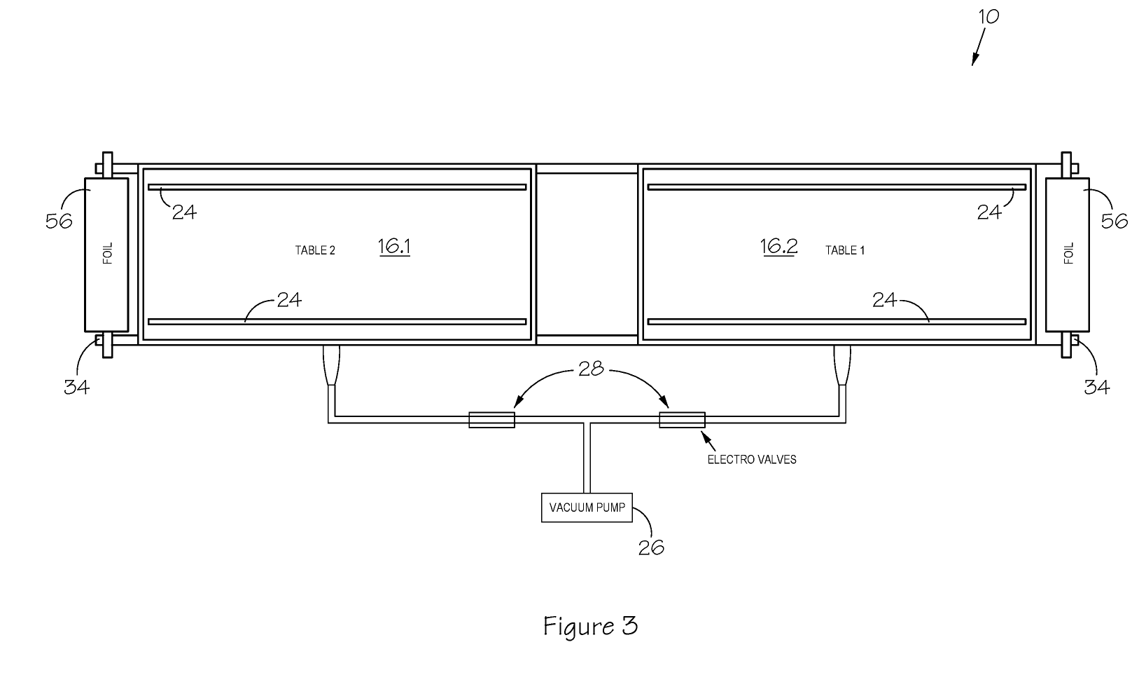

Referring to FIG. 3 in particular, the apparatus 10 also comprises a vacuum device comprising a vacuum pump 26 operatively connected to the chamber 20 via suitable electronically actuatable or controllable valves 28. The pump 26 is operable to remove air from the chamber 20 by suction once the same is sealed by the lid 22 in the second position thereby creating a vacuum in the chamber 20.

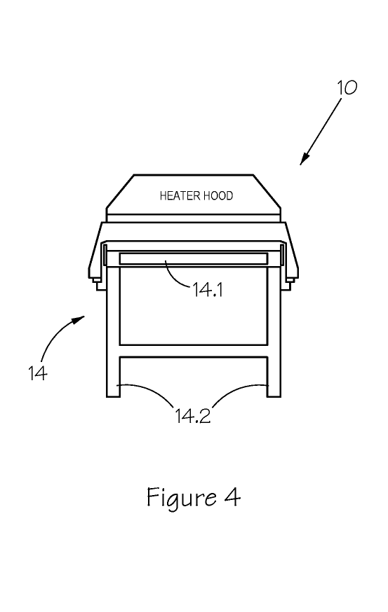

Referring to FIGS. 1 and 4 in particular, the apparatus 10 further comprises a heater 30. The heater 30 is typically configured to heat the chamber 20 to a predetermined temperature. In particular, the heater 30 is configured to heat the chamber 20 to preferably between 80 and 90° C.

The heater 30 is typically slidably displaceable on the frame 14 in the direction of arrows A & B (FIG. 1) so as to move between bed 16.1 and bed 16.2. Though not shown, the heater 30 may comprise fourteen heater bars of 1200 W each.

The apparatus 30 also comprises an electrical panel 32 housing electronics and/or electrical circuitry to control the heater 30 and pump 26 and/or valves 28. It will be noted that the circuitry may be conventional control circuitry configurable in a plurality of different configurations to achieve the control functionality desired.

To facilitate ease speed of production of the panels 12 as will be described below, the apparatus 10 comprises laminate holders 34 located at ends of the top 14.1 of the frame 14. The holders 34 may be in the form of rollers for mounting of rolls of laminate material thereon, wherein the laminate material may be drawn or unrolled therefrom directly on the beds 16.1, 16.2 as will be described below.

Though not shown, the apparatus may comprise a pressure means to apply a force on the membrane, in use so as to facilitate driving the laminating material in the groove, in use. The pressure means may be in the form of a pneumatic pressurising means configured to apply a pneumatic pressure above the membrane so as to urge the membrane to engage with the substrate, in use.

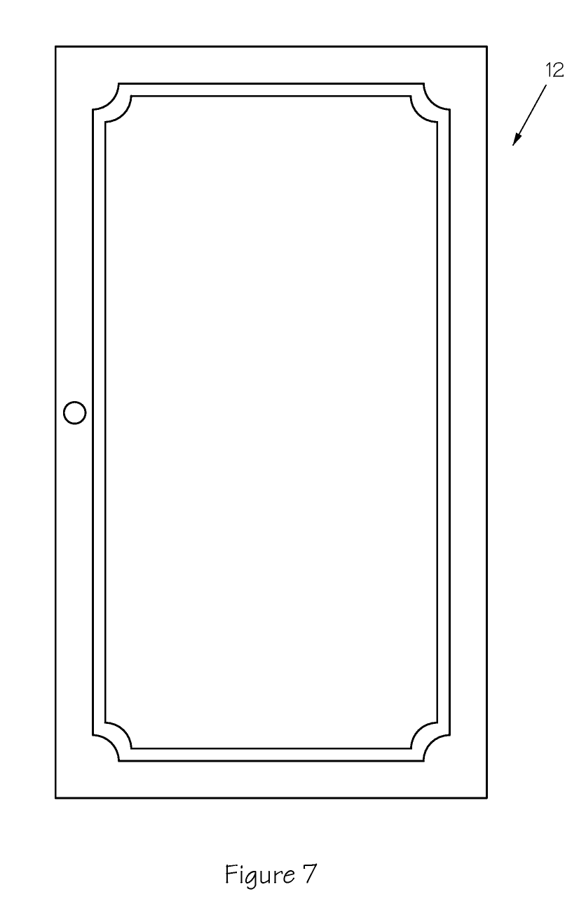

In use, the apparatus 10 is typically used to form a panel 12 of the type illustrated in FIGS. 5 to 7. In the example embodiment, the panel 12 is in the form of a door panel as illustrated in FIG. 7. However, prior to using the apparatus 10, the panel 12 must be prepared.

To this end, it will be appreciated that the panel 12 comprises a substrate 50 of fibreboard/MDF. The substrate 50 is typically planar slab with a pair of opposite major faces interconnected by strip-like walls providing thickness to the substrate 50. The thickness of the substrate 50 may vary as the case may be, for example, the thickness of the substrate may be a thin skin attachable to a hollow core door, or may be an already formed door.

In any event, a groove pattern or patterned groove 52 is first formed in the substrate 50, on a major face thereof, for example, by hand, preferably way of a CNC (Computer Numerical Control) machine, or the like. It will be noted that the groove 52 is typically cut, etched, or pressed into the substrate 50 and is typically decorative.

The surface of the substrate 50 with the groove 52 is then sanded down to prepare the same for coating with a layer of adhesive such as glue 54. The glue 54 must dry, thus it is left on a drying rack to dry for approximately 15 on warm days and approximately 25 minutes on cold days. For example, temperatures in the environment in which the panel 12 is manufactured is considered a cold day if it falls below 15° C., whereas for a hot day the temperatures are over 20° C.

Once the adhesive 54 has suitably dried, the lid 22 is actuated to the first position thereby exposing the bed 16.1, 16.2. The substrate 50 is located on the bed 16.1 and paper laminating material 56 on a roll is drawn from the roller 34 (in the direction of arrow B) and located on the substrate 50, on top of the layer of dried glue 54. The material 56 may be paper-based or paper-like, though it will be appreciated that using a paper or paper-based laminating material 56 decreases costs and provides a wider range of finishes. Most typically, the material 56 is selected to resemble a typically more expensive wood grain. In addition, it will be noted that the material 56 is in the form of a sheet having a thickness of less than that of the substrate 50.

In some example embodiments, it will be noted that the material 56 may be located on the substrate 50 and then placed on the 16.1 of the apparatus 10.

In any event, once the material 56 is positioned on the substrate 50, the material 56 is cut relative to size and the lid 22 is closed and secured so that the chamber 20 is provided with an airtight seal.

The heater 30 is then moved, for example, in a slidable fashion in the direction of the arrows A/B (depending on where the heater 30 was located) to be directly over the chamber 20 associated with the bed 16.1 so as to provide heat thereto.

The vacuum 26 is then actuated by suitable circuitry to remove the air from the chamber 20 and suck the membrane lid 22 into the groove/s 52 thereby urging the paper laminating material 56 on which the membrane 22 rests also into the patterned groove/s groove 52. Additionally, a pressurising means may be actuated to force the membrane 22 to further engage the substrate, particularly, to urge the laminating material 56 into the groove 52. In some example embodiments the pressuring means may be in the form of a mechanical member operable to exert a force on the membrane 22.

The heater 30 is then actuated by operation of the control circuitry to heat up the chamber 20 which causes the material 56 to further deform slightly and in particular activate the adhesive 54 so that the paper laminating material 56 being urged into the groove/s 52 by the membrane 22 (under vacuum) bonds to the substrate 50 and into the groove/s 52 thereof. The vacuum process takes approximately 3 minutes.

Though the temperature at which heating takes place is typically between 80 and 90° C., it will be understood that the temperature may vary depending on the temperature which the adhesive activates.

It will be noted that once the bonding is completed, the excess material 56 is trimmed away. The panel formed in the fashion may be attached as one or both major surfaces of a door of the type illustrated in FIG. 7. To this end the panels formed in accordance with the invention may be attached to side or lateral walls and/or internal frame components of the door (not shown) by one or more of nails, screws, adhesives, and the like. In this way a hollow core door is formed with panels of the type mentioned herein.

It will be understood by those skilled in the field of the invention that already formed doors having major surfaces thereof comprised of the substrate 50, may also be processed in a fashion described herein to bond the laminating material 56 thereto to achieve the desired effect as illustrated in the door of FIG. 7.

By providing two beds 16.1, 16.2, the output capacity for forming panels 12 of the type described herein is doubled. Similarly further scaling up or scaling down of capacity may be achieved by varying the number of beds.

The invention as described herein provides a means of laminating a fibreboard substrate having a patterned groove with a laminate material in a convenient and inexpensive manner. In this way, laminated panels for use, as doors, cladding, etc. may be provided with patterned grooving.

1. A method for forming a panel or skin for a hollow core door, the method comprising:
providing fibreboard substrate comprising a groove pattern therein;
applying a paper or paper-like laminating material on the substrate with an adhesive therebetween;
sealing the substrate with the paper laminating material thereon in a chamber and providing at least one deformable membrane adjacent the paper laminating material;
removing air from the chamber so as to form a vacuum therein, wherein under vacuum, the deformable membrane deforms into the groove pattern thereby urging the paper laminating material into the groove pattern,
heating the paper laminating material on the substrate so as to facilitate bonding of the paper laminating material to the substrate; and
allowing the substrate with the laminating material thereon to cool so as to form a panel or skin with the laminating material suitably bonded thereto.

2. A method as claimed in claim 1, wherein the method comprises the step of applying the adhesive to one or both of the substrate or the laminating material allowing the adhesive to cool for a predetermined period.

3. A method as claimed in claim 2, wherein heating the paper laminating material operatively activates the adhesive.

4. A method as claimed in any one of the preceding claims, wherein the method comprising sanding the surface of the substrate prior to the application of adhesive thereto.

5. A method as claimed in any one of the preceding claims, wherein the membrane is elastically deformable, wherein the method comprises the membrane elastically deforming so as to urge the laminating material into the groove pattern, at least in response to the vacuum generated in the chamber.

6. A method as claimed in any one of the preceding claims, wherein the method comprises applying a force to the membrane so as to drive the membrane to urge the laminating material into the groove pattern.

7. A method as claimed in any one of claims 1 to 6, wherein the method comprises pressurising a zone above the membrane pneumatically so as to drive the membrane to urge the laminating material into the groove pattern.

8. A method as claimed in any one of the preceding claims, wherein the method comprises locating the substrate with the laminating material thereon in a hermetically sealable chamber prior to heating the laminating material via the membrane.

9. A method as claimed in any one of the preceding claims, wherein the method comprises the step of trimming excess laminating material from a periphery of the panel.

10. A method as claimed in any one of the preceding claims, wherein the method comprises either forming the panel or skin prior to attachment to a hollow frame door, or while the substrate is attached to the hollow frame door.

11. A method of manufacturing a hollow core door, the method comprising attaching one or a pair of panels or skins formed according to the method of any one of claims 1 to 10 to at least lateral walls of the hollow core door such that the one or pair of panels or skins serve as one or both major faces of the hollow core door and said lateral walls extend transversely thereto or therebetween.

12. A method as claimed in claim 11, wherein the method comprises attaching the one or pair of panels or skins to the lateral walls of the hollow core door by way of one or more of adhesives, nails, screws, and staples.

13. A hollow core door comprising at least one panel formed according to the method as claimed in any one of claims 1 to 10.

14. A panel or skin formed in accordance with a method as claimed in any one of claims 1 to 10.

15. An apparatus for forming a panel or skin for a hollow core door, the apparatus comprising:
a sealable chamber comprising an elastically deformable lid to provide access to the chamber, the chamber being shaped and configured to receive a substrate of the panel or skin to be formed;
a heater configured to heat the sealable chamber;
a vacuum device configured to remove air from the sealable chamber, in use, thereby substantially forming a vacuum therein;
control circuitry to control the heater one or both of the heater and vacuum device.

16. An apparatus as claimed in claim 15, wherein the apparatus comprises a frame on which a bed on which the substrate is locatable.

17. An apparatus as claimed in claim 16, wherein the lid is displaceable relative to the bed and/or the frame between first and second positions wherein in the first position, access to the chamber is provided and wherein in the second position the lid sealing engages the bed and/or the frame so as to define the chamber.

18. An apparatus as claimed in claim 15, wherein the lid is configured to be elastically deformable in response to at least the vacuum formed in the chamber.

19. An apparatus as claimed in claim 16, wherein the apparatus comprises sealing members adjacent peripheries of the lid and the bed and/or frame.

20. An apparatus as claimed in any one of claims 15 to 19, wherein the apparatus comprises a pressuring means operable to force the membrane to urge the laminating material into a groove pattern in the substrate.
